(19) United States
(12) Patent Application Publication
(10) Pub. No.: US 2005/0091152 A1
(43) Pub. Date: Apr. 28, 2005

(54) Method and System for Approving Card Transactions

(76) Inventor: Daniel Suisa, Jakarta (ID)

Correspondence Address: DANIEL SUISA, JL. WALET PERMAI 4/33, PANTAL INDAH KAPUK, JAKARTA, 14470, ID

(21) Appl. No.: 10/605,720

(22) Filed: Oct. 22, 2003

(51) Int. Cl. G06F 17/60

(52) U.S. Cl. 705/39

(57) ABSTRACT

A system and method for approving credit or debit card transactions is provided. Transaction data such as an amount of money to be settled is obtained by a cardholder. A digital signature of the cardholder is generated based on the transaction data, wherein the transaction data can additionally include a cardholder's reference number. The generated digital signature is included in the request for approval message. Accordingly, the received digital signature is verified by the card issuer to either approve or disapprove the transaction.

### BACKGROUND OF INVENTION

The invention relates to the approval of card transactions by card issuers and more specifically to the approval of credit/debit card transactions based on the digital signatures of cardholders.

In the world of plastic cards, particularly credit cards, for many years, considerable efforts have been made to eliminate or at least minimize the financial losses resulting from mistakenly approving fraudulent transactions.

A typical credit card transaction is performed when a cardholder hands over their credit card to a merchant. The merchant performs a request for approval operation by swiping the card to an electronic point of sale (POS) terminal to acquire the necessary card account data stored in a magnetic stripe of the credit card. The merchant also inputs other transaction data including the purchase amount to form a request for approval message. The request for approval message is then transmitted to the card issuer via an acquirer service provider.

The acquirer service provider provides a POS terminal management system that manages/controls all installed POS terminals at the merchant sites. The POS terminal is usually owned by the acquirer service provider and placed at the merchant site. The acquirer service provider obtains merchants as customers and then installs the POS terminals at the merchant sites. The acquirer service provider then manages the installed POS terminals.

The acquirer service provider and the card issuer can be the same, for example AMEX, which acquires the merchants and places the POS terminals at the merchant sites, while also issuing AMEX credit cards to cardholders. Acquiring the merchants and issuing the cards to cardholders are two different businesses. In a company such as AMEX, the two functions are done by the same company but run by different business units.

The VISA/Mater Card system illustrates a different acquirer/issuer arrangement. Some banks can be both issuers and acquirers, while other banks might be only card issuers. For example, bank-A can be both an acquirer and an issuer, while bank-B and bank-C might only be card issuers. If a customer of bank -B or bank-C uses the services of bank-A, then bank-A might charge a fee to bank-B or bank-C.

The acquirer service provider can also be a non-bank (independent entity), which acquires the merchants and provides the POS terminals. This type of acquirer service provider often charges fees to all the card issuers, usually financial institutions, for using its services. In summary, the acquirer service provider usually controls the merchant and POS terminal side of the transactions while the card issuer manages the cardholder and the card issuer side of the transactions.

The conventional way of approving a credit card transaction is typically based on the status of the card account information stored in a database of the card issuer such as the credit limit and the card validity, without really knowing whether the user of the card is the true cardholder. The card data, typically stored in the magnetic strip on the backside of the card, can be easily copied to another card and this “copied card” can be used to perform fraudulent transactions. These fraudulent transactions will be repeatedly approved by the card issuer until either the card issuer or the true cardholder realize that such frauds have occurred.

The growth of transactions over the Internet using credit cards has been limited by the inadequacy of security means to protect the effected parties such as the card issuers and the cardholders.

Debit cards with a PIN based security scheme are better at minimizing the fraudulent plastic card transactions. However, the PIN (personal identification number) is a fix code, which bears a risk of discovery by others when used out in the open. Moreover, such a scheme encounters many challenges when transactions are performed over the Internet, as the PIN may be disclosed to unauthorized parties.

IC cards, more generally known as smart cards, are replacing the conventional magnetic stripe cards, as the smart cards can provide better security. However, the use of smart cards requires much time and expense to replace (or at least upgrade) all existing point-of-sale terminals at merchant sites, which typically accept magnetic stripe cards, with new terminals that can accept the smart cards. This involves huge labor costs for replacing/upgrading the terminals, training the users, etc. Doing this on a world wide basis is a very expensive and time consuming proposition.

It would be desirable to provide a method and system that is able to make use of the existing infrastructures, while at the same time both providing a secure way for credit and debit cardholders to use the cards for performing transactions, and providing a secure way for the cards issuers to approve the transactions.

### SUMMARY OF INVENTION

The present invention provides a method and system for approving a credit card transaction, based on a dynamic digital signature of a cardholder in addition to the conventional way of approving the transaction.

The present invention further provides a method and system for approving a debit card transaction, based on a dynamic digital signature of a cardholder instead of or in addition to using a PIN.

Firstly, transaction data is obtained by a cardholder. The transaction data can include an amount of money to be settled. The transaction data can additionally include other data such as card account data, a cardholder's reference number, a merchant identification data, a point-of-sale terminal identification data and other related data.

Secondly, a digital signature of the cardholder is generated based on the transaction data.

Accordingly, the card issuer verifies the digital signature to thereby approve or disapprove the transaction.

The present invention can assure credit cardholders and encourage them to use the card for performing transactions without worrying about disclosing the card data to others, while at the same time protecting the card issuer from bearing the risk of approving fraudulent transactions caused by unauthorized use of the cards.

The present invention can further encourage a debit cardholder to use the card for transacting without having to use the PIN number in an open environment, especially in transactions over the Internet.

The present invention provides a secure way of purchasing goods and services, paying bills, mortgage loans, etc. over the Internet using credit or debit cards.

The present invention further provides a secure way of purchasing goods and services, paying bills, mortgage loans, etc. through a publicly available self-service terminal using credit or debit cards.

When the present invention is used, lost or stolen cards do not need to be reported since transactions using these cards will not be approved by the issuer without the presence of the digital signature of the true cardholder. Additionally, the card data, such as the card number of a lost or stolen card, can be reused on a replacement card without the card issuer having to assign new card data. This invention even allows the cardholder's official identification number such as a social security number, to be used as part of the card account number, rather than using a conventional numbering system, while still providing good security.

The present invention further reduces the cost of producing the card itself, without the need for sophisticated hologram and other attributes for preventing the imitation of the card, since there is no incentive for the imitator to do so.

The replacement/upgrading of terminals, as well as the re-training, waste the precious time of the merchants who are supposed to focus on the business. The present invention can be implemented over the existing infrastructure, maintaining the use of existing point-of-sale terminals at merchant sites, without the need to replace or upgrade the existing point-of-sale terminals and re-train the merchants in the use of new technologies.

The present invention protects the interests of all involved parties such as the card issuer, the cardholder, an acquirer and the merchant.

The present invention is independent of the technology. In the case of the decision has been made to go for a smart card or other technologies to replace the conventional magnetic stripe card, the present invention can well be applied.

### BRIEF DESCRIPTION OF DRAWINGS

FIG. 1 is a flow chart illustrating the method of the present invention.

FIG. 2 is a simplified diagrammatic view of a cardholder apparatus for implementing the embodiments.

FIG. 3 is a simplified diagrammatic view of a card issuer apparatus for implementing the embodiments.

FIG. 4A is a flow chart illustrating an exemplary embodiment of the present invention.

FIG. 4B is a schematic representation of the embodiment of FIG. 4A.

FIG. 5A shows a display on the cardholder apparatus before the signature is generated according to the embodiment of FIG. 4A.

FIG. 5B shows a display on cardholder apparatus after the signature is generated according to the embodiment of FIG. 4A.

FIG. 5C shows a simplified request for approval message transmitted from the merchant terminal to the card issuer apparatus according to the embodiment of FIG. 4A.

FIG. 5D shows a simplified authorization message transmitted from the card issuer apparatus to the merchant terminal according to the embodiment of FIG. 4A.

FIG. 5E shows a transaction slip according to the embodiment of FIG. 4A.

FIG. 6 is a flow diagram of an exemplary embodiment for producing a short signature with improved security.

FIGS. 7A-B show several examples of the data combination techniques according to the embodiment of FIG. 6.

### DETAILED DESCRIPTION

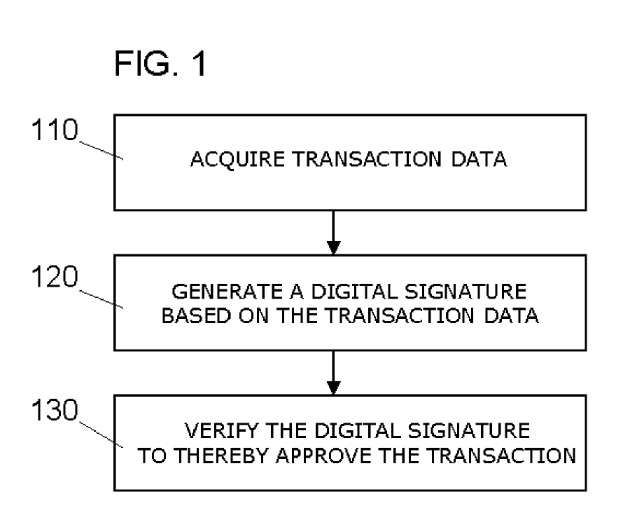

FIG. 1 illustrates the general method of the present invention. The method comprises three general steps.

The first step 110 is the step of acquiring the transaction data. The transaction data such as an amount is normally obtained from a merchant at the point of sale or displayed on the screen in a transaction over the Internet.

The second step 120 is the step of generating a cardholder's digital signature. The digital signature is generated based on the transaction data. The transaction data can include an amount of money to be settled and other data such as merchant identification data, point-of-sale terminal identification data, etc. The transaction data can further include a card account number and other data specific to the cardholder such as a cardholder's reference number, etc.

The cardholder's reference number is a number that is unique for each transaction of a cardholder and therefore has a dynamic or changing value. More generally the reference number can be referred to as a reference code since it can include numbers and/or letters and/or other symbols. Using a reference number along with the digital signature increases the security of the card transactions. For example, without the reference number the same digital signature might be generated for purchases for the same amount of money. Thus, fraudulent transactions can be performed by copying a previously used signature and once again charging or debiting the same amount of money. On the other hand, when a unique reference number is provided for each transaction, it is much harder to perform such fraudulent transactions.

The cardholder's reference number can either be produced at the card issuer apparatus or at the cardholder apparatus. The card issuer can more generally be referred as a card transaction approver and the card issuer apparatus can thus more generally be referred to as a card transaction approver apparatus.

When the cardholder's reference number is produced at the card issuer apparatus, the reference number can be issued by the card issuer based on the request from the cardholder or based on the initiative of the card issuer.

The request and the issuance of the reference number(s) are preferably done through electronic means such as SMS (short messaging services), MMS (multimedia messaging services) or e-mail. The reference number can be a serial number or a specific number generated using a special mathematical formula.

When the reference number is produced at the cardholder apparatus and the serial number is being used, the card issuer can assign a starting number to a cardholder and the apparatus increments it for each transaction. Alternatively, the reference number can also be a random number generated within the apparatus. In any case, where a reference number is to accompany a digital signature, the card issuer also needs to be able to determine what value the reference number accompanying the digital signature should have for a given transaction in order to verify the transaction.

Alternatively, in the case when the reference number is a serial number, the reference number does not need to accompany the digital signature since the card issuer (i.e. the card issuer apparatus) always knows the value of the reference number for the transaction/next transaction. This scheme allows the cardholder to present less data (only the digital signature and not the reference number is needed) for convenience and practicality. This scheme requires the value of the reference number at the cardholder's side to always be in synchronization with the value of the reference number at the card issuer's side. This scheme can be implemented by having a function in the cardholder apparatus (discussed below) for recovering the used reference number, in case a digital signature has already been generated but not used due to the cancellation of a transaction, for example.

There are many other ways of implementing the cardholder's reference number.

The third step 130 is the verification step. The card issuer apparatus verifies the received digital signature, approves the transaction and sends an authorization message to the merchant apparatus typically via an acquirer apparatus provided by an acquirer service provider. The acquirer apparatus can be a POS terminal or can be a computer, for example, when the transaction is performed over the Internet.

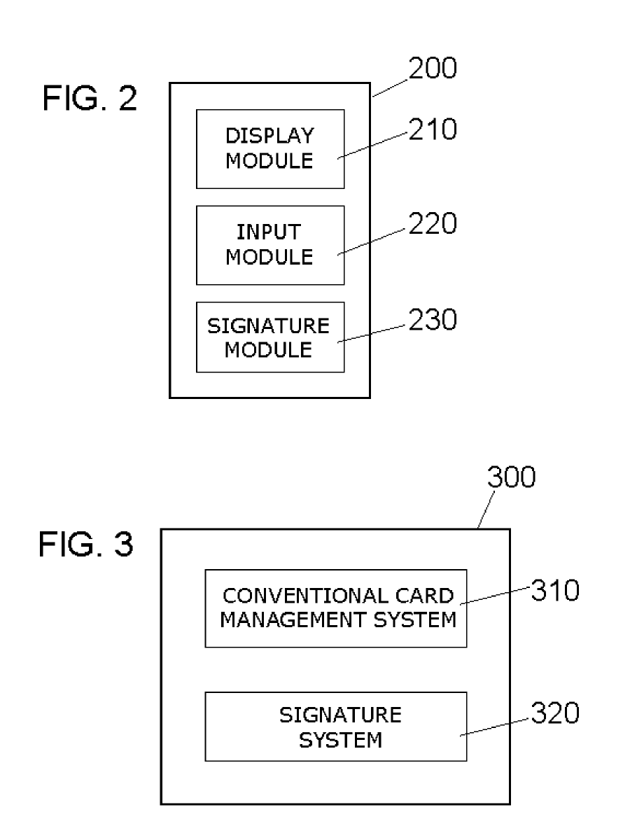

A cardholder apparatus 200 of FIG. 2 such as a cellular phone, a PDA, or any handheld mobile electronic device, is equipped with at least a display module 210, an input module 220 and a signature module 230. The signature module 230 can include at least: an existing cryptographic algorithm(s) or a specific mathematical formula for generating a digital signature; a file for storing the cardholder's secret key(s); a file for storing the cardholder's reference number(s) or an alternative program based on specific mathematical formula for producing the cardholder's reference number or an alternative program for producing a random number instead; a file for storing the card account data such as card account number, cardholder's name, card type, issuer name, etc.; and a file for keeping the transaction records.

A card issuer apparatus 300 of FIG. 3 is equipped with at least a conventional (prior art) card management system 310 and a signature system 320. The signature system 320 can include at least: a signature program, which corresponds to that of apparatus 200, for verifying the received digital signature; a database for storing the corresponding secret keys of the cardholders.

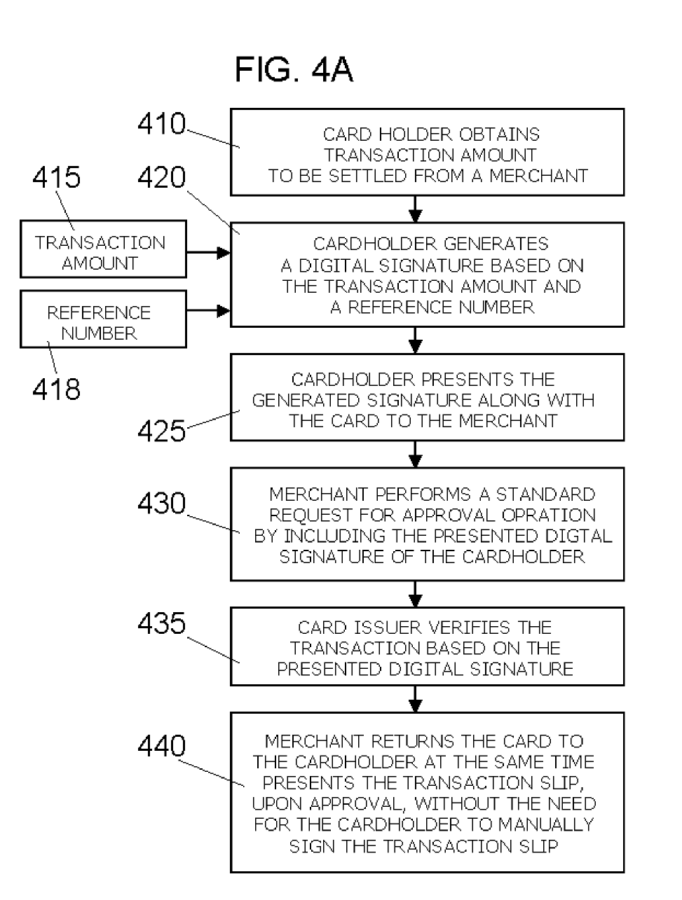

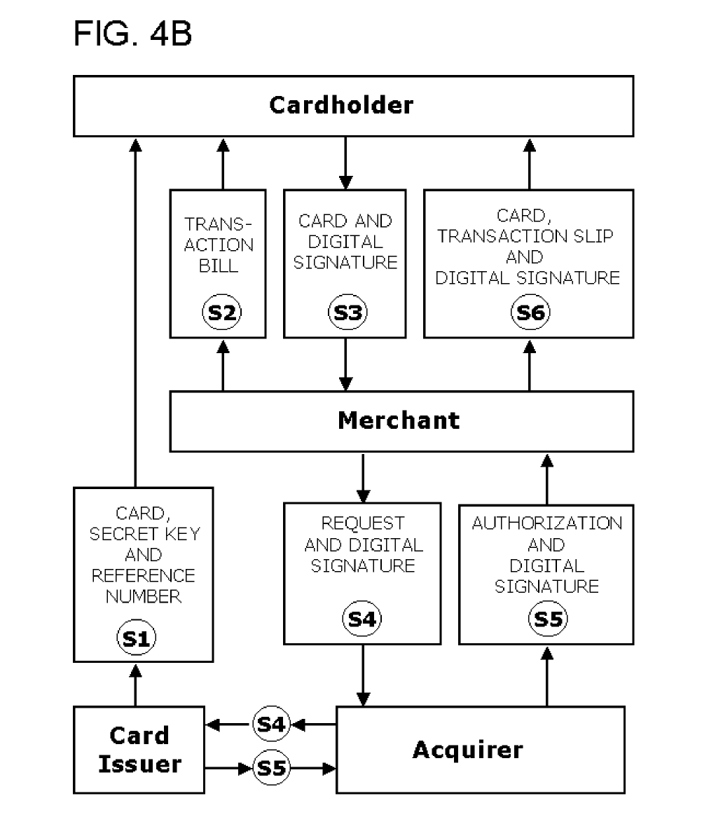

The detailed steps of the embodiment are now described with additional reference to FIGS. 4A and 4B.

At step S1, a cardholder is issued one or more secret keys (depending on the signature scheme being used) and reference numbers, which are securely stored in a cardholder's apparatus. The storage and access of the secret key(s) and the reference number(s) are preferably controlled through an authentication process. The authentication can be done using password/PIN and/or biometric means. The secret key can alternatively be issued by an authorized third party. When an open-key cryptosystem such as RSA is being used, the cardholder can be assigned a pair of private and public keys, where the public key can be shared among several card issuers.

At step 410, when a transaction is to be settled, a cardholder obtains transaction data such as transaction amount to be settled from a merchant or a vendor (see step S2).

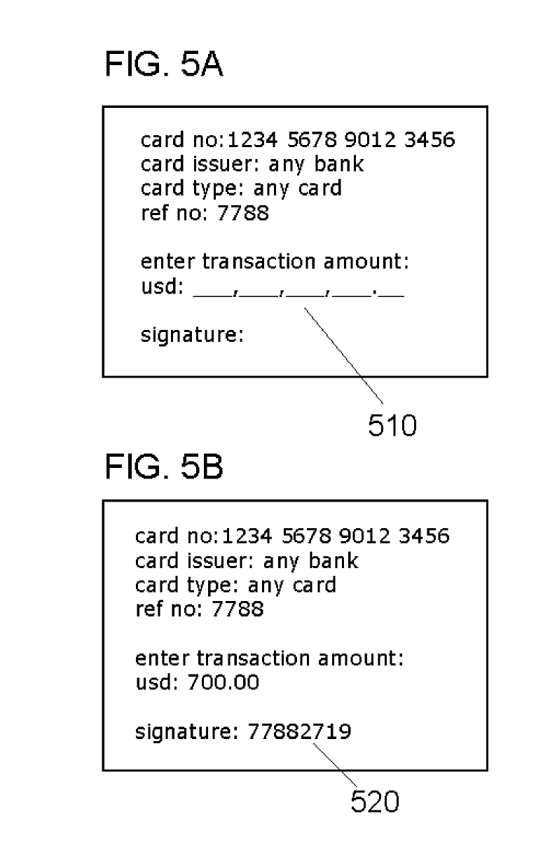

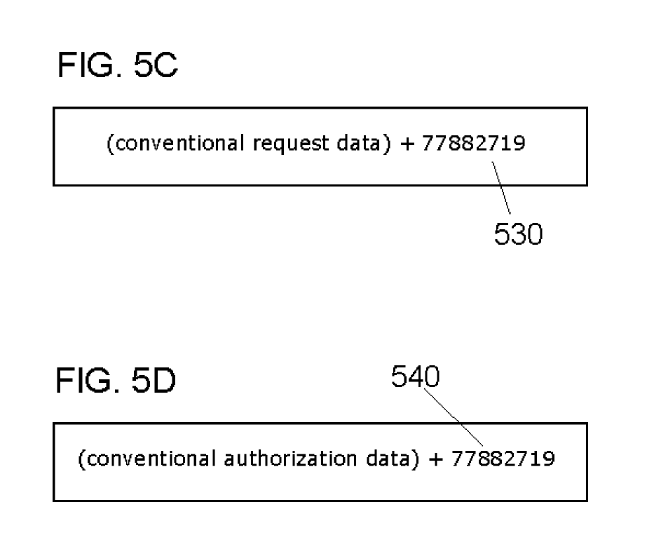

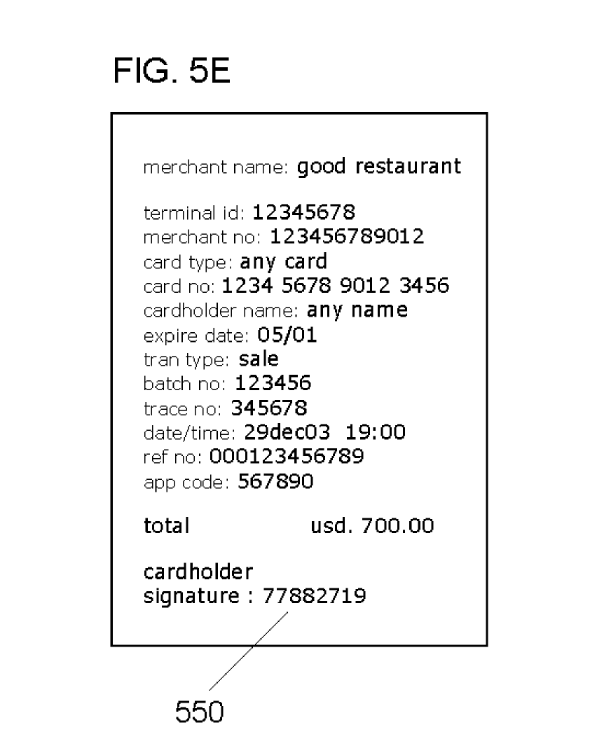

At step 420, upon obtaining the transaction amount 415, the cardholder activates the signature module 230 preferably through an authentication process. The display module 210 displays the screen of FIG. 5A, where the cardholder is prompted to enter the transaction amount 415 at the position 510 on the screen. A pre-stored cardholder's reference number 418 is automatically extracted from a file within the cardholder apparatus 200. A digital signature 520 shown on the display in FIG. 5B is then generated based on the amount 415 and the reference number 418, employing the pre-stored cardholder's secret key with the cryptosystem. The card data such as the card account number pre-stored in the apparatus 200 can optionally be included in the signature generation. Note that the signature 520 contains the reference number, where the first 4 characters are the reference number concatenated with the last 4 characters of the signature itself (reference number||signature). The 4-character signature can be obtained from a portion of a signature generated by applying a symmetric cryptosystem such as DES or 3DES to the transaction data.

At step 425, the generated digital signature 520 is presented to the merchant such as by writing on the bill or a piece of paper, for example. The cardholder also presents the card to the merchant along with the generated signature (see step S3).

At step 430, upon obtaining the signature and the card, the merchant performs a standard request for approval operation, for example, by swiping the card to the merchant apparatus such as an electronic point of sale (POS) terminal to acquire the necessary card account data stored in the magnetic stripe, followed by inputting the other transaction data including the amount to form a request for approval message. At this stage, the presented digital signature is also input to the merchant apparatus for inclusion in the request for approval message, which is then transmitted to the card issuer apparatus 300 via the acquirer apparatus (see step S4). FIG. 5C shows an example of a request for approval message including a digital signature 530, which is transmitted from the merchant apparatus to the card issuer apparatus 300.

At step 435, upon receiving the request for approval message from the merchant apparatus, the card issuer apparatus 300 performs a standard verification process along with additional verification of the received cardholder's digital signature and reference number. Note that the 4-character signature is first extracted from the received signature which includes the reference number concatenated to the 4-character signature (reference number||signature). A second signature is generated based on the required transaction data using the cardholder's corresponding secret key pre-stored in the database of the card issuer apparatus 300. Next, the extracted 4-character signature is compared with the first 4 characters of the second signature. Upon verification and approval of the transaction, the apparatus 300 sends an authorization message to the merchant apparatus via the acquirer apparatus (see step S5). FIG. 5D shows an example of data contained in an authorization message including a digital signature 540, which is transmitted from the card issuer apparatus 300 to the merchant apparatus.

At step 440, upon receiving the authorization message from the card issuer apparatus 300, the merchant apparatus prints a transaction slip as shown in FIG. 5E with the digital signature (reference number 11 signature) 550 printed on the transaction slip. The card is then returned to the cardholder along with the printed transaction slip (see step S6), without the need for the cardholder to manually sign the transaction slip. The transaction is thereby completed.

Note that only the effected parties such as the cardholder and the card issuer are discussed in detail. The acquirer is only mentioned briefly.

The steps S2, S3 and S6 of FIG. 4B, alternatively, can be done electronically such as by means of wireless communication between the cardholder's apparatus and the merchant's apparatus. In such a case: in step S2, the transaction data is electronically transmitted from the merchant's apparatus to the cardholder's apparatus; in step S3, the card data and the generated signature are electronically transmitted from cardholder's apparatus to the merchant's apparatus; and in step S6, a transaction journal containing the digital signature are electronically transmitted from the merchant's apparatus to the cardholder's apparatus.

The embodiment of FIG. 4B can be securely applied to transactions over the Internet. Disclosure of the card data to the merchant over the Internet bears no risk at all due to the fact that the approval of the transaction depends upon the dynamic digital signature of the cardholder. In such a case: at step S2, a transaction amount is displayed on the screen; at step S3, a card data and a digital signature are input to the system; and at step S6, a notification of the status of the transaction can be provided to the cardholder. The merchant can be a goods supplier, a service provider, a mortgage lender, etc.

Other embodiments for non-transactional requests such as the change of credit limit, request for supplemental card, etc. can also be done through telephone or the Internet.

Certain signature generation techniques can be used to produce a short signature for convenience and practicality, especially if the digital signature is to be presented manually.

One example for generation and verification of a signature employs a symmetric cryptosystem such as DES. At the generation step 120 of FIG. 1: (1) encrypt the transaction data using cardholder's secret key; and (2) take a portion of the encrypted data, for example, the first 4 characters to be the signature. At verification step 130 of FIG. 1: (1) encrypt the same transaction data using the corresponding secret key to produce another encrypted data; and (2) take the first 4 characters of the newly encrypted data and compare with the signature.

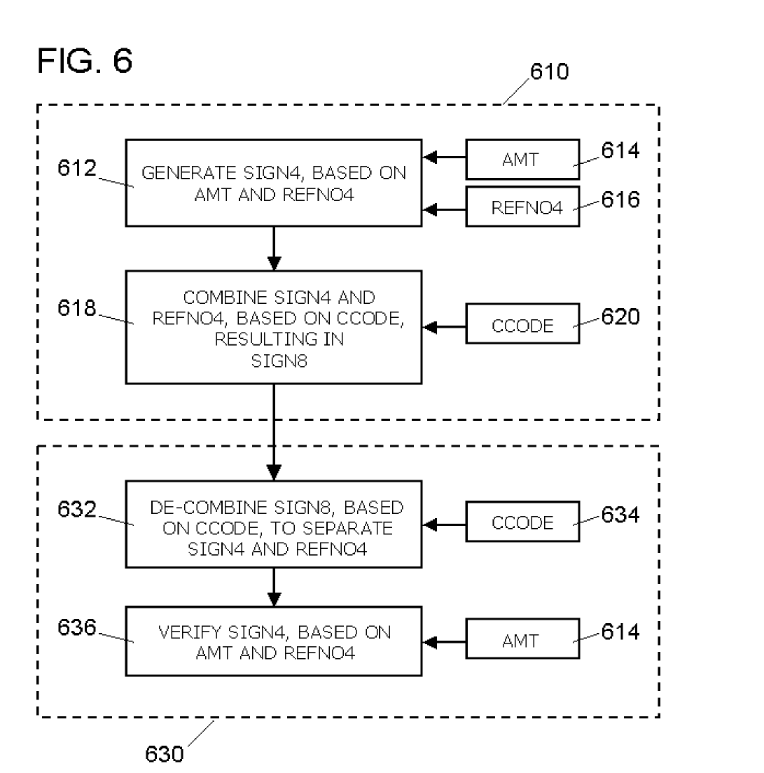

FIG. 6 illustrates an embodiment for producing a short signature with improved security. In this example, for illustrative purpose, the signature has a length of 4 characters and the reference number has a length of 4 characters. Each cardholder is assigned a particular combination code in similar fashion to a PIN (personal identification number). The 4-character signature and the 4-character reference number are combined or mixed into a single 8-character code, based on a given combination code. The resulting 8-character code is then used as the digital signature for the transaction. The embodiment has 2 main sections, which are the combination section 610 and the de-combination section 630.

To implement the combination section 610, the cardholder apparatus 200 of FIG. 2 is further facilitated with: a file for securely storing a particular combination code; and a sub-program for combining the 4-character intermediate signature and the 4-character reference number into a single 8-character code based on the given combination code.

To implement the de-combination section 630, the card issuer apparatus 300 of FIG. 3 is further facilitated with: a database for securely storing the corresponding combination code for each cardholder; and a subprogram for separating/recovering the 4-character intermediate signature and the 4-character reference number from the received 8-character signature code based on the given corresponding combination code.

The combination code for each cardholder can be changed from time to time such as by downloading the new combination code to the cardholder apparatus 200 through SMS, for example. Every change of the combination code at the apparatus 200 will also reflect the change of the corresponding combination code in the card issuer database at the apparatus 300. The change of the combination code can be based on the cardholder request or the card issuer initiative. Furthermore, the change of the combination code can optionally be done through an ATM or other electronic delivery channels.

The combination section 610 is now described. At the signature generation step 612, a 4-character signature “SIGN4” is generated based on the transaction amount “AMT” 614 and the 4-character reference number “REFNO4” 616. The reference number can be a random number generated at the apparatus 200 or a pre-stored number issued by the card issuer.

At step 618, the generated “SIGN4” is combined with the “REFNO4” 616 to produce an 8-character code “SIGN8”, based on the combination code “CCODE”620 pre-stored at the cardholder apparatus 200. The resulting “SIGN8” is then used as the signature of the transaction.

The de-combination section 630 is now described. At step 632, the received 8-character signature code “SIGN8” is de-combined to separate or recover the 4-character code “SIGN4” and the reference number “REFNO4” based on the corresponding combination code “CCODE” 634, associated with the cardholder, pre-stored at the card issuer apparatus 300.

At step 636, the recovered “SIGN4“is then verified based on the received amount 614 and the recovered reference number “REFNO4”.

The use of the combination code 620 along with the reference number 616 provides even more security than using just the reference number 616. As mentioned above, the reference number 616 can help prevent fraud where the same digital signature is used for purchases for the same amount of money. However, there is still the possibility of fraud if an unauthorized party can determine the reference number 616. The combination code 620 provides even greater security by making it difficult for an unauthorized party to determine the reference number just by looking at a digital signature.

Note that in the above description, the 4-character code “SIGN4” and the 4-character reference number “REFNO4” were used merely for illustrative purposes. Other lengths of character codes can also be used. The signature can be produced using a symmetric cryptosystem such as DES or another mathematical formula, and a portion of the generated code, for example the first 4 characters of the generated code can be taken to produce “SIGN4”.

The embodiment of FIG. 6, based on the secrecy of the combination code, optionally allows a digital signature to be generated without using any cryptographic algorithm or a complex mathematical formula. Instead, the digital signature can be generated using a very simple arithmetic operation such as an “addition” or a “subtraction”. For example, the reference number is randomly generated at the cardholder apparatus 200 of FIG. 2. At the generation step 612, a first signature is produced by adding the reference number to the amount. The amount can be truncated or padded to the required length. At the combination step 618, the first signature is combined with the reference number based on the combination code, securely pre-stored in the apparatus 200 to produce a second signature. At the de-combination step 632, the received second signature is de-combined to separate or recover the first signature and the reference number based on the corresponding combination code, securely pre-stored at the card issuer apparatus 300. At the verification step 636, a verification signature is produced by adding the recovered reference number to the received amount in the same way as in the generation step 612 above. The resulting verification signature is then compared with the recovered first signature. The card account number can additionally be used in the arithmetic operation. Note that the security of this scheme depends solely on the secrecy of the combination code.

Furthermore, multiple combination codes can be assigned and maintained in the cardholder apparatus and dynamically selected by the cardholder for each transaction. In this case, a combination code identifier for the selected combination code is required, which can be embedded within the signature code.

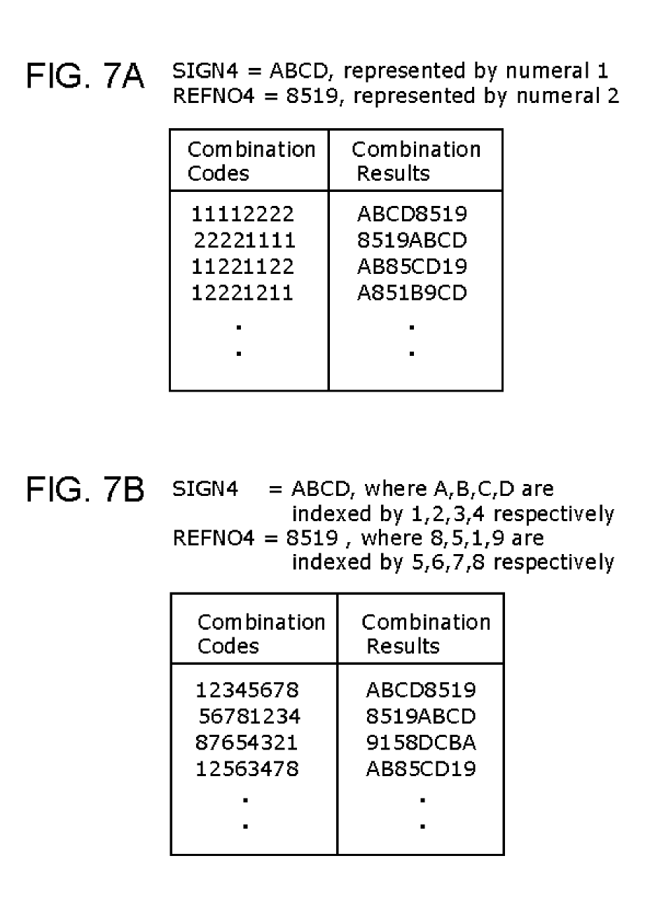

FIGS. 7A and 7B show several examples of defining the combination codes between the 4-character code “SIGN4” and the 4-character reference number “REFNO4” according to the embodiment of FIG. 6. The particular values of alphabetic “ABCD” for “SIGN4” and numeral “8519” for “REFNO4” are for illustrative purposes and the invention is of course not limited to these values.

The present invention may be embodied in other forms without departing from its spirit and scope. The embodiments described above are therefore illustrative and not restrictive, since the scope of the invention is determined by the appended claims rather then by the foregoing description, and all changes that fall within the meaning and range of equivalency of the claims are to be embraced within their scope.

1. A system for approving a card transaction using a card of a cardholder comprising:
a digital signature generated by a signature generation section of a cardholder apparatus based on transaction data and a reference code of the cardholder which changes for each transaction by the cardholder; and
a verification section for receiving a request for approval message including the digital signature and verifying the received digital signature to thereby approve the transaction.

2. The system of claim 1, wherein the transaction data includes a transaction amount.

3. The system of claim 2, wherein the transaction data further includes account information of the cardholder.

4. The system of claim 2, wherein the reference code is either issued from the issuer or generated at the cardholder's apparatus.

5. The system of claim 2, wherein the transaction data further includes merchant identification information.

6. The system of claim 2, wherein the transaction data further includes point-of-sale terminal identification information.

7. The system of claim 1, wherein the generation the signature is done through authenticating the cardholder.

8. The system of claim 1, further comprising a request for approval message of the transaction including the generated digital signature.

9. The system of claim 1, wherein the card includes a card number comprising an official identification number such as the social security number of the cardholder.

10. The system of claim 1, wherein:
the signature generation section further comprises a combination code and a second digital signature produced by combining the digital signature and the reference code based on the combination code;
and the verification section is also for receiving the second digital signature and separating the received second digital signature to recover the digital signature and the reference code based on the corresponding combination code for then verifying the digital signature to thereby approve the transaction.

11. The system of claim 10, wherein the combination code is electronically transmitted from a card issuer apparatus to the cardholder's apparatus by a transmission means selected from the group consisting of: a wireless short messaging service (SMS), a wireless multimedia messaging service (MMS), and e-mail.

12. The system of claim 1, wherein the card is a credit card.

13. The system of claim 1, wherein the card is a debit card.

14. The system of claim 1, wherein the card is in the form of an electronic chip exchanging information with the cardholder apparatus.

15. The system of claim 1, wherein the verification section is part of a card issuer apparatus controlled by a card issuer.

16. A method for approving a card transaction between a cardholder and a seller comprising the steps of: acquiring transaction data; acquiring a cardholder reference code, wherein the reference code changes for each transaction; generating a digital signature based on the transaction data and the reference code; transmitting a request for approval message from the seller; and verifying the digital signature to thereby approve the transaction.

17. The method of claim 16 wherein the step of transmitting the request for approval message includes transmitting the generated digital signature in the request for approval message.

18. The method of claim 16, wherein the transaction data includes a transaction amount and the generating step includes generating the digital signature based on the transaction amount and a reference code of the cardholder.

19. The method of claim 18, wherein the generating step includes combining the generated digital signature and the reference code based on a combination code.
